(19) United States
(12) Patent Application Publication
(10) Pub. No.: US 2024/0147474 A1
(43) Pub. Date: May 2, 2024

(54) METHODS AND DEVICES FOR SEMI-PERSISTENT SCHEDULING WITH MULTI-TRANSMISSION AND RECEPTION POINT

(71) Applicant: Samsung Electronics Co., Ltd., Gyeonggi-do (KR)

(72) Inventors: Mohamed Mokhtar Gaber Moursi AWADIN, San Diego, CA (US); Jung Hyun BAE, San Diego, CA (US); Hamid SABER, San Diego, CA (US); Hoda SHAHMOHAMMADIAN, San Diego, CA (US)

(21) Appl. No.: 18/489,070

(22) Filed: Oct. 18, 2023

Related U.S. Application Data
(60) Provisional application No. 63/421,398, filed on Nov. 1, 2022.
(60) Provisional application No. 63/425,516, filed on Nov. 15, 2022.
(60) Provisional application No. 63/438,581, filed on Jan. 12, 2023.

(51) Int. Cl. H04W 72/1273; H04L 1/1829; H04W 72/0446

(52) U.S. Cl. CPC H04W 72/1273; H04L 1/1854; H04W 72/0446

(57) ABSTRACT

Methods and apparatuses are provided in which a first number of repetitions of a semi-persistent scheduling (SPS) physical downlink shared channel (PDSCH) within a given slot is determined. A second number of slot repetitions within an SPS period is determined based on at least one of an aggregation factor of an information element (IE) or a repetition number of a time domain resource allocation. The SPS PDSCH is received in accordance with the first number of repetitions within the given slot and the second number of slot repetitions within the SPS period.

### CROSS-REFERENCE TO RELATED APPLICATION

This application claims the priority benefit under 35 U.S.C. § 119(e) of U.S. Provisional Application Nos. 63/421,398, 63/425,516, and 63/438,581, filed on Nov. 1, 2022, Nov. 15, 2022, and Jan. 12, 2023, respectively, the disclosures of which are incorporated by reference in their entirety as if fully set forth herein.

### TECHNICAL FIELD

The disclosure generally relates to transmission and reception operations at a user equipment (UE). More particularly, the subject matter disclosed herein relates to improvements in semi-persistent scheduling (SPS) at a UE supporting multi-transmission and reception point (TRP) operation.

### SUMMARY

In new radio (NR), in order to handle a potential collision between a dynamic physical downlink shared channel (PDSCH) and a semi-persistent scheduling (SPS) PDSCH, a particular timeline has been provided to define user equipment (UE) behavior. Specifically, if a time gap between a last symbol of a physical downlink control channel (PDCCH) that schedules the dynamic PDSCH and a first symbol of the SPS PDSCH is at least x symbols, the UE receives the dynamic PDSCH and not the SPS PDSCH. Alternatively, if the time gap is less than x symbols, an error case occurs since the UE does not expect the collision to occur. When two linked PDCCH candidates are received, the timeline may be defined relative to the later PDCCH candidate.

A similar timeline has been provided to handle a potential collision between a dynamic physical uplink shared channel (PUSCH) and a configured grant (CG) PUSCH. Specifically, a UE may not be expected to receive a PDCCH scheduling a PUSCH overlapping in time with a CG PUSCH when the time gap from the last symbol of the scheduling PDCCH is less than N₂ symbols. The value of N₂ may be determined according to UE processing capability.

However, the timeline described above does not consider whether the dynamic PDSCH or the dynamic PUSCH is scheduled from the same transmission and reception point (TRP) as that used for the SPS PDSCH or the CG PUSCH, respectively. The limitations resulting from the timeline may impose scheduling restrictions that may not be necessary if the UE is capable of simultaneously receiving PDSCHs from different TRPs or transmitting PUSCHs from different TRPs.

To solve this problem, the timeline may be enhanced to reflect UE capabilities and avoid unnecessary scheduling restrictions.

Additionally, enhancements have been provided that enable multi-TRP (m-TRP) PDSCH reception using a single scheduling PDCCH (i.e., single-downlink control information (s-DCI)) or multiple scheduling PDCCHs (i.e., multi-DCI (m-DCI)). However, these enhancements were developed for the dynamic PDSCH, and not the SPS PDSCH.

With respect to m-TRP PDSCH reception using s-DCI, the activation DCI may indicate two transmission configuration indicator (TCI) states. When a repetitionNumber is configured in the time domain resource allocation (TDRA) table for the dynamic PDSCH, the indicated TCI states may be applied according to cyclic or sequential mapping across the indicated repetitionNumber of consecutive slots. For the SPS PDSCH, it may not be clear which TCI state should be applied to different PDSCH occasions. It may also not be clear how the indicated repetitionNumber should interact with a pdsch-AggregationFactor for SPS, if both are configured. For the dynamic PDSCH, the UE does not expect to be configured with the repetitionNumber and the pdsch-AggregationFactor.

When a time division multiplexing (TDM) scheme (e.g., tdmSchemeA) is configured for the dynamic PDSCH, two PDSCHs are transmitted with a gap of StartingSymbolOffsetK symbols therebetween. For the SPS PDSCH, it may not be clear how tdmSchemeA should be applied. Additionally, it may not be clear how this operation mode should interact with the pdsch-AggregationFactor for SPS in terms of counting the number of PDSCH occasions.

When a frequency division multiplexing (FDM) scheme (e.g., fdmSchemeB) is configured for the dynamic PDSCH, two FDM-ed PDSCHs may be transmitted. Similar to tdmSchemeA, for the SPS PDSCH, it may not be clear how fdmSchemeB should be applied and how this operation mode should interact with the pdsch-AggregationFactor.

To overcome these issues, systems and methods are described herein for allowing the UE to receive an SPS PDSCH and a dynamic PDSCH transmitted from different TRPs regardless of whether the time gap between a last symbol of the PDCCH scheduling the dynamic PDSCH and the first symbol of the SPS PDSCH is less than the threshold.

In an embodiment, a method is provided in which a UE determines a first number of repetitions of a SPS PDSCH within a given slot. The UE determines a second number of slot repetitions within an SPS period based on at least one of an aggregation factor of an information element (IE) and a repetition number of a time domain resource allocation. The UE receives the SPS PDSCH in accordance with the first number of repetitions within the given slot and the second number of slot repetitions within the SPS period.

In an embodiment, a UE is provided that includes a processor and a non-transitory computer readable storage medium storing instructions. When executed, the instructions cause the processor to determine a first number of repetitions of an SPS PDSCH within a given slot, determine a second number of slot repetitions within an SPS period based on at least one of an aggregation factor of an IE or a repetition number of a time domain resource allocation, and receive the SPS PDSCH in accordance with the first number of repetitions within the given slot and the second number of slot repetitions within the SPS period.

In an embodiment, a method is provided in which a UE determines a first number of slot repetitions within an SPS period for an SPS PDSCH based on at least one of an aggregation factor of an IE or a repetition number of a time domain resource allocation. The UE receives the SPS PDSCH in accordance with the first number of slot repetitions within the SPS period. The first number of slot repetitions is based on the aggregation factor and comprises one or more sets, with each of the one or more sets having a second number of slots corresponding to the repetition number, and a last set having a third number of slots that is less than or equal to the second number of slots.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating a communication system, according to an embodiment;

FIG. 2 is a diagram illustrating m-TRP PDSCH reception supporting dynamic and SPS PDSCHs partially overlapped in time and frequency domains, according to an embodiment;

FIG. 3 is a diagram illustrating m-TRP PDSCH reception supporting dynamic and SPS PDSCHs partially overlapped in the time domain and not overlapped in the frequency domain, according to an embodiment;

FIG. 4 is a diagram illustrating m-TRP PDSCH reception supporting dynamic and SPS PDSCHs partially overlapped in the time domain and fully overlapped in the frequency domain, according to an embodiment;

FIG. 5 is a diagram illustrating m-TRP PDSCH reception supporting dynamic and SPS PDSCHs fully overlapped in the time domain and not overlapped in the frequency domain, according to an embodiment;

FIG. 6 is a diagram illustrating m-TRP PDSCH reception supporting an SPS PDSCH overlapping a dynamic PDSCH repetition from a different TRP, according to an embodiment;

FIG. 7 is a diagram illustrating m-TRP PDSCH reception supporting an SPS PDSCH overlapping a dynamic PDSCH repetition from the same TRP, according to an embodiment;

FIG. 8 is a diagram illustrating a medium access control (MAC) control element (CE) associating TCI states with TRPs, according to an embodiment;

FIG. 9 is a diagram illustrating a MAC-CE indicating a TRP associated with an activated TCI state, according to an embodiment;

FIG. 10 is a flowchart illustrating a method of UE operation with overlapping dynamic scheduled and non-dynamic scheduled channels, according to an embodiment;

FIG. 11 is a diagram illustrating dividing PDSCH repetitions into multiple sets of an SPS period, according to an embodiment;

FIG. 12 is a diagram illustrating allocated slots for the SPS PDSCH repetitions using a TDM scheme, according to an embodiment;

FIG. 13 is a diagram illustrating allocated slots for the SPS PDSCH repetitions using a TDM scheme, according to another embodiment;

FIG. 14 is a diagram illustrating allocated slots for SPS PDSCH repetitions using an FDM scheme, according to an embodiment;

FIG. 15 is a diagram illustrating allocated slots for SPS PDSCH repetitions using an FDM scheme, according to another embodiment;

FIG. 16 is a flowchart illustrating a method of SPS PDSCH repetition in an SPS period, according to an embodiment; and

FIG. 17 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without the se specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

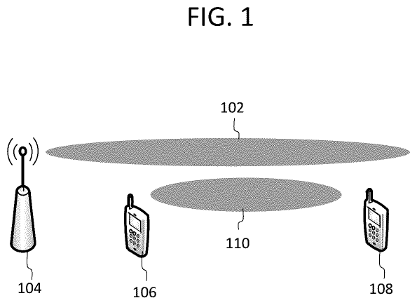

FIG. 1 is a diagram illustrating a communication system, according to an embodiment. In the architecture illustrated in FIG. 1, a first path 102 may enable the transmission of control information and data through a network established between a base station or a gNode B (gNB) 104, a first UE 106, and a second UE 108. A second path 110 may enable the transmission of data (and some control information) on a sidelink between the first UE 106 and the second UE 108. The first path 102 and the second path 110 may be on the same frequency or may be on different frequencies.

Herein, the term “dynamic channel” refers to a dynamic scheduled channel that is scheduled by DCI. The term “non-dynamic channel” refers to a non-dynamic scheduled channel, such as SPS PDSCH and CG PUSCH.

In NR, a gNB may not be able to schedule a dynamic PDSCH that fully or partially overlaps an SPS PDSCH in the time domain, resulting in an error case, unless the DCI that schedules the dynamic PDSCH is at least a threshold number of symbols (e.g., Δ=14.2^{max(0,μ-3)}) before an earliest starting symbol of the SPS PDSCH. The symbol duration and μ may be based on a smallest numerology between a scheduling PDCCH and the SPS PDSCH. When the timeline involving the threshold is satisfied, the UE may cancel reception of the SPS PDSCH and may receive the dynamic PDSCH. However, this rule may apply regardless of whether the dynamic PDSCH and the SPS PDSCH are transmitted by the same TRP or different TRPs.

Embodiments described herein, or any of their combinations, are provided to alleviate the unnecessary restriction that occurs when the SPS PDSCH and the dynamic PDSCH are transmitted from different TRPs and the UE supports m-TRP operation.

For a DCI scheduling a single PDSCH, the UE may receive the SPS PDSCH and the dynamic PDSCH regardless of the time gap between the PDCCH scheduling the dynamic PDSCH and the first symbol of SPS PDSCH, when the PDCCH and SPS PDSCH are transmitted from different TRPs.

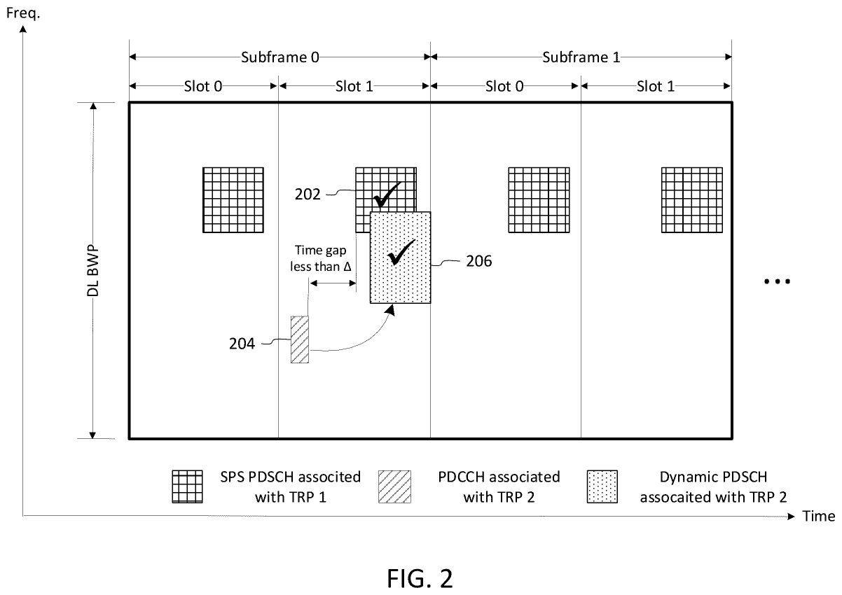

FIG. 2 is a diagram illustrating m-TRP PDSCH reception supporting dynamic and SPS PDSCHs partially overlapped in time and frequency domains, according to an embodiment. In a second slot (e.g., slot 1) of a first subframe (e.g., subframe 0), an SPS PDSCH 202 may be associated with a first TRP (e.g., an activation PDCCH is transmitted in a control resource set (CORESET) with coresetPoolIndex-r16 set to 0), and a PDCCH 204 scheduling a dynamic PDSCH 206 may be associated with a second TRP (e.g., transmitted in a CORESET with coresetPoolIndex-r16 set to 1). Although a time gap between a last symbol of the PDCCH 204 and a first symbol of the SPS PDSCH 202 is less than the threshold number of symbols (e.g., Δ symbols), the UE may be able to receive both the dynamic PDSCH 206 and the SPS PDSCH 202 due to the different TRPs.

In order to handle such reception, the UE may declare that it supports any 3^{rd} generation partnership project (3GPP) Rel-16 multiple-input multiple-output (MIMO) design as part of its capability signaling.

Alternatively, the UE may declare that it supports m-DCI m-TRP PDSCH reception (e.g., feature group (FG) 16-2a, 16-2a-0 or 16-2a-1), which may include reception of PDSCHs overlapped in the time domain, with no, full, or partial overlap in the frequency domain.

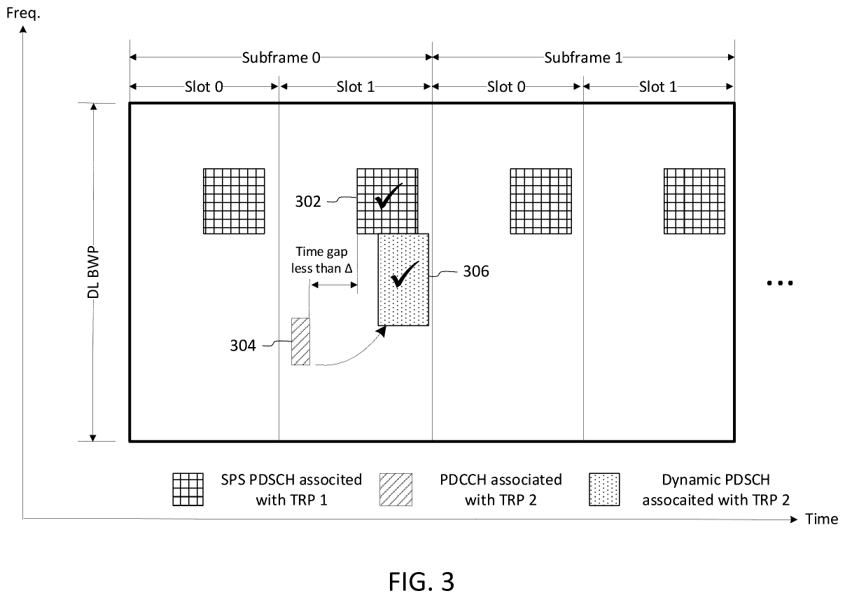

FIG. 3 is a diagram illustrating m-TRP PDSCH reception supporting dynamic and SPS PDSCHs partially overlapped in the time domain and not overlapped in the frequency domain, according to an embodiment. Specifically, if the UE indicates that it supports FG 16-2a, although a time gap between a last symbol of a PDCCH 304 that schedules a dynamic PDSCH 306 and a first symbol of an SPS PDSCH 302 is less than the threshold number of symbols (e.g., Δ symbols), the UE may be able to receive both the dynamic PDSCH 306 and the SPS PDSCH 302 due to the different TRPs.

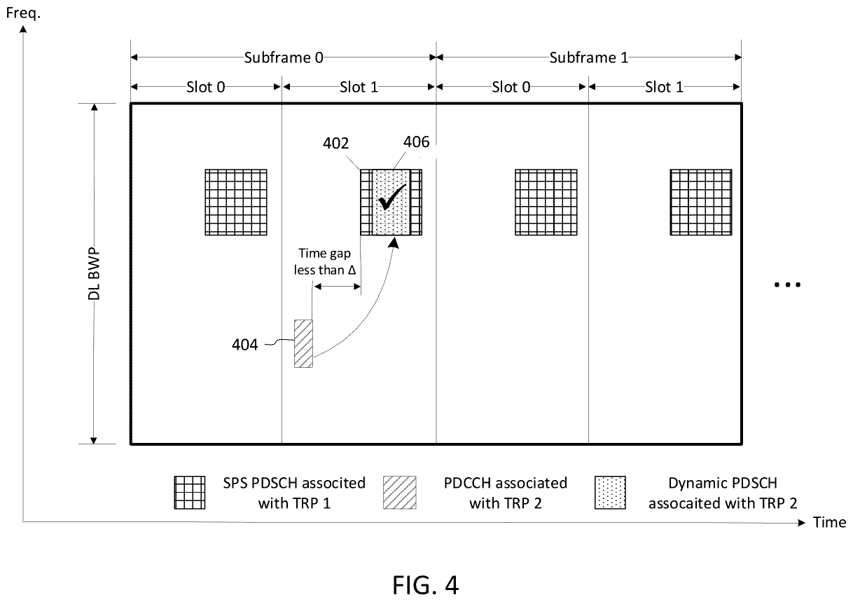

FIG. 4 is a diagram illustrating m-TRP PDSCH reception supporting dynamic and SPS PDSCHs partially overlapped in the time domain and fully overlapped in the frequency domain, according to an embodiment. Specifically, if the UE declares that it supports FG 16-2a-0, although a time gap between a last symbol of a PDCCH 404 that schedules a dynamic PDSCH 406 and a first symbol of an SPS PDSCH 402 is less than the threshold number of symbols (e.g., Δ symbols), the UE may be able to receive both the dynamic PDSCH 406 and the SPS PDSCH 402 due to the different TRPs.

If the UE declares that it supports FG 16-2a-1, although a time gap between a last symbol of the PDCCH 204 that schedules the dynamic PDSCH 206 and a first symbol of the SPS PDSCH 202 is less than the threshold number of symbols (e.g., Δ symbols), the UE may be able to receive both the dynamic PDSCH 206 and the SPS PDSCH 202 due to the different TRPs, as shown in FIG. 2. In this scenario, the dynamic PDSCH 206 and the SPS PDSCH 202 may be overlapped in the time domain and partially overlapped in the frequency domain.

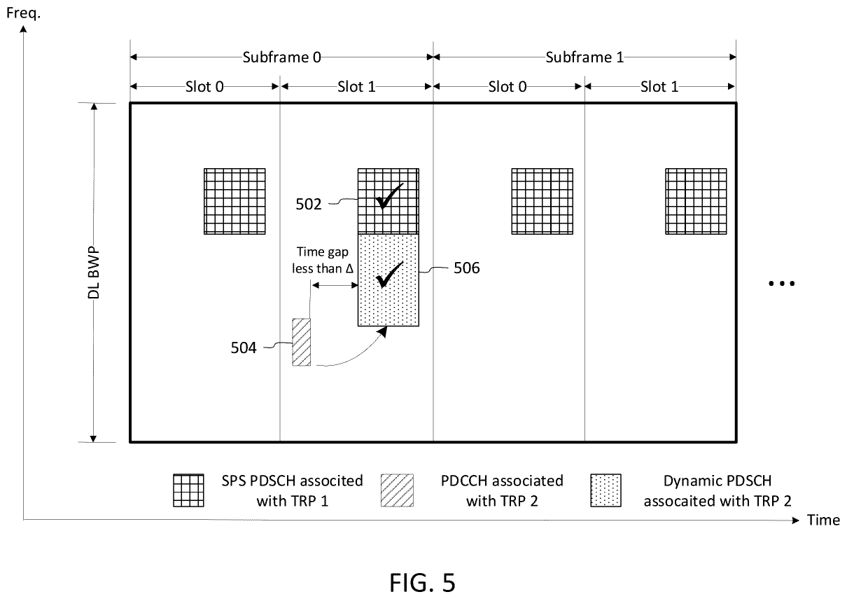

FIG. 5 is a diagram illustrating m-TRP PDSCH reception supporting dynamic and SPS PDSCHs fully overlapped in the time domain and not overlapped in the frequency domain, according to an embodiment. In order to for the UE to be able to receive an SPS PDSCH 502 and a dynamic PDSCH 506 that is scheduled by a PDCCH 504 when the timeline between the first symbol of the SPS PDSCH 502 and the last symbol of the PDCCH 504 with respect to the threshold (e.g., Δ symbols) is not satisfied, the UE may declare that it supports a m-TRP PDSCH reception, such as, for example, fdmSchemeB (e.g., FG 16-2b-3 or 16-2b-3a). The UE may expect that the SPS PDSCH 502 and the dynamic PDSCH 506 are fully overlapped in time domain, but are not overlapped in the frequency domain. Additionally, the UE may assume that demodulation reference signal (DMRS) ports assigned for the SPS PDSCH 502 and the dynamic PDSCH 506 are within the same code division multiplexing (CDM) group.

The UE may indicate that it supports reception of a dynamic PDSCH and an SPS PDSCH associated with different TRPs, separate from the capability signaling associated with 3GPP Rel-16 MIMO design. The UE may indicate whether the SPS PDSCH and the dynamic PDSCH should be non-overlapped, partially overlapped, or fully overlapped in the time domain or the frequency domain.

Another threshold may be specified between a PDCCH associated with a first TRP and an SPS PDSCH associated with a second TRP, during which the UE is capable of receiving both the SPS PDSCH and the dynamic PDSCH, which are partially or fully overlapped in the time domain.

The UE may indicate, to the gNB, a minimum amount of time needed between the scheduling PDCCH and the first symbol of SPS PDSCH such that the UE can receive both the SPS PDSCH and the dynamic PDSCH associated with different TRPs. This indication may part of UE capability signaling.

With respect to a DCI scheduling multiple PDSCHs, different repetition schemes have been supported in NR, where the repetitions may be transmitted from different TRPs. Therefore, the UE may determine the TRP used for transmitting the dynamic PDSCH repetition and determine whether it is the same TRP used for the SPS PDSCH.

If the dynamic PDSCH repetition that overlaps the SPS PDSCH is transmitted from a different TRP, the UE may be able to receive both the dynamic PDSCH repetition and the SPS PDSCH despite the scheduling PDCCH of the dynamic PDSCH not satisfying the threshold timeline. However, if the dynamic PDSCH repetition overlaps the SPS PDSCH from the same TRP, and the scheduling PDCCH of the dynamic PDSCH does not satisfy the threshold timeline, this may be considered an error case.

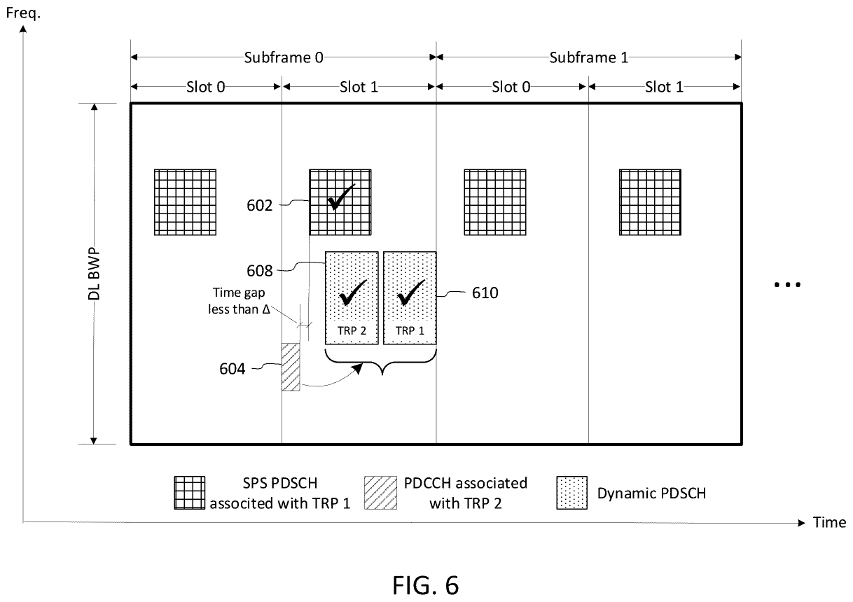

FIG. 6 is a diagram illustrating m-TRP PDSCH reception supporting an SPS PDSCH overlapping a dynamic PDSCH repetition from a different TRP, according to an embodiment. Specifically, an SPS PDSCH 602 is shown to partially overlap a first dynamic PDSCH repetition 608 in the time domain, and not overlap a second dynamic PDSCH repetition 610. Despite a time gap between a last symbol of a PDCCH 604 and a first symbol of the SPS PDSCH 602 being less than the threshold, the UE may receive both the SPS PDSCH 602 from a first TRP and the first dynamic PDSCH repetition 608 from a second TRP, followed by the second dynamic PDSCH repetition 610 from the first TRP. The first dynamic PDSCH repetition 608 and the second dynamic PDSCH repetition 610 may be scheduled according to tdmSchemeA, though embodiments are not limited to this scheduling scheme and other scheduling schemes may be applied.

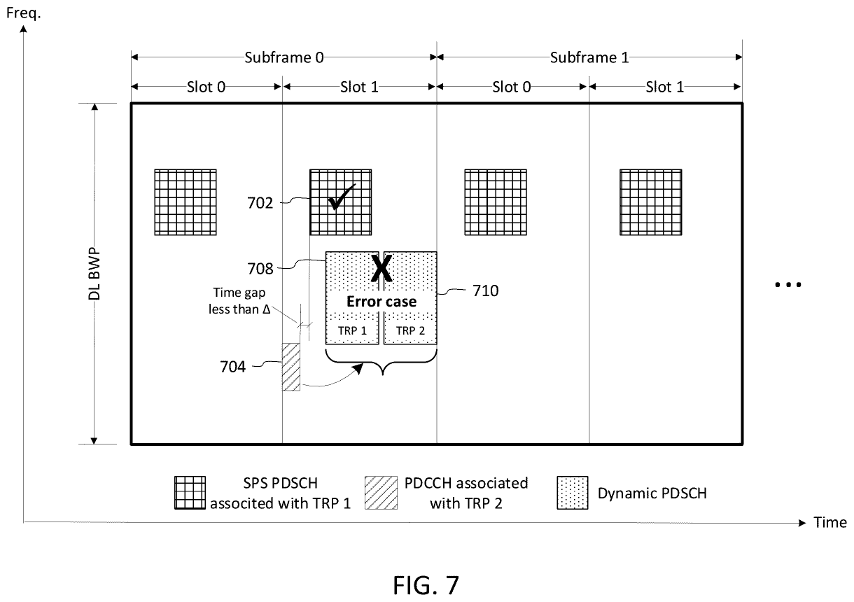

FIG. 7 is a diagram illustrating m-TRP PDSCH reception with an SPS PDSCH overlapping a dynamic PDSCH repetition from the same TRP, according to an embodiment. FIG. 7 differs from FIG. 6 in that a first dynamic PDSCH repetition 708 is transmitted from the first TRP and a second dynamic PDSCH repetition 710 is transmitted from the second TRP. FIG. 7 results in an error case because an SPS PDSCH 702 and the first dynamic PDSCH repetition 708 are transmitted from the same TRP, and a time gap between a last symbol of a scheduling PDCCH 704 of the dynamic PDSCH repetitions 708 and 710 and a first symbol of the SPS PDSCH 702 is less than the threshold.

Accordingly, the UE may determine whether a dynamic PDSCH repetition is transmitted from the same TRP as that used for the SPS PDSCH. However, using only the framework of a m-TRP PDSCH reception using s-DCI may not be sufficient for such a determination, since a TCI codepoint pointing to two TCI states is not necessarily mapped to different TRPs.

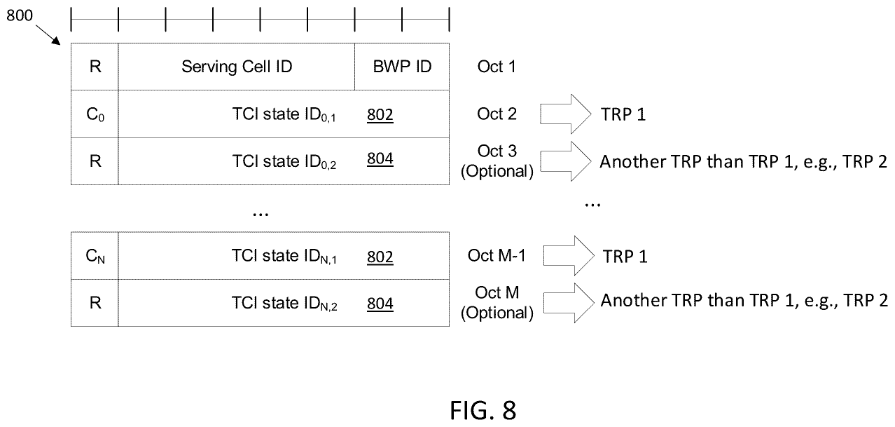

FIG. 8 is a diagram illustrating a MAC CE associating TCI states with TRPs, according to an embodiment. A MAC-CE 800, which is used for activating and associating a TCI codepoint with a single TCI state or two TCI states, may also be used to establish a link between an indicated TCI state and a TRP. A simple rule may be applied. For example, for each codepoint of the DCI TCI field indicated in an enhanced TCI activation MAC-CE, a first TCI state 802 may be assumed to be linked with a first TRP and a second TCI state 804 (if present) may be assumed to be linked with a second TRP.

Referring back to FIGS. 6 and 7, based on the indicated TCI codepoint, the UE may determine whether or not the overlapped dynamic PDSCH repetition and the SPS PDSCH are transmitted from different TRPs. When the dynamic PDSCH repetition and the SPS PDSCH are transmitted from different TRPs, the UE may receive both PDSCHs even if the time gap between the PDCCH and the SPS PDSCH is less than the specified threshold Δ.

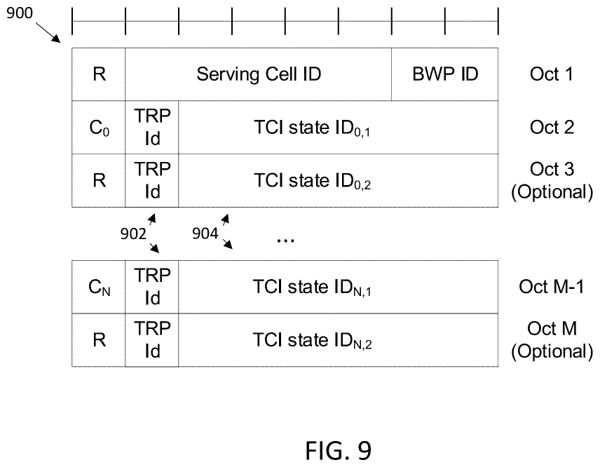

FIG. 9 is a diagram illustrating a MAC CE indicating a TRP associated with an activated TCI state, according to an embodiment. A TCI activation MAC CE 900 or the enhanced TCI activation MAC-CE may explicitly indicate a TRP identifier (ID) associated with an activated TCI state. For example, the MAC CE 900 may carry an additional field indicating a TRP index 902 of a corresponding activated TCI state 904. In order to avoid changing the MAC-CE size, one bit from the TCI state ID field 904 in the MAC-CE 900 may be used to indicate the TRP (e.g., if set to 0 or 1, it indicates TRP 1 or 2, respectively). This bit may be the most significant bit of the TCI state ID field 904 in the MAC-CE 900.

Alternatively, the gNB may indicate, to the UE, which TRP is associated with the configured TCI state using higher layer signaling. For example, a new radio resource control (RRC) parameter may indicate the TRP index and it may be included in TCI-state IE.

According to another embodiment, if a quasi-colocation (QCL) source reference signal (RS) of the TCI state of an SPS PDSCH and the QCL source RS of the TCI state of a dynamic PDSCH are in different resource sets (e.g., non-zero power (NZP) channel state information (CSI)-RS resource set ID (NZP-CSI-RS-ResourceSetId) or CSI synchronization signal block (SSB) resource set ID (CSI-SSB-ResourceSetId)), the UE may assume that the dynamic PDSCH (or a repetition) and the SPS PDSCH are transmitted from different TRPs.

This embodiment may depend on configuring, for example, groupBasedBeamReporting-v17. Specifically, the network may configure two resource sets, which may be two NZP CSI-RS resource sets, two CSI SSB resource sets, or one NZP CSI-RS resource set and one CSI-SSB resource set. If the QCL source RS of the TCI states associated with the SPS PDSCH and the dynamic PDSCH belong to different resource sets, then the UE may be capable of receiving both regardless of the time gap between the PDCCH and the SPS PDSCH.

The UE may be expected to be able to receive the overlapped SPS PDSCH and dynamic PDSCH when the gap between PDCCH and SPS PDSCH is less than the threshold Δ, only when the QCL source RSs of the TCI states of both PDSCHs is one of the pair RSs indicated to be received simultaneously by the UE. Specifically, when the UE is configured with groupBasedBeamReporting or groupBasedBeamReporting-r17, the UE may report multiple pairs of RS IDs, in which RSs belonging to the same pair may be received simultaneously. When the QCL source RSs of the TCI states of the SPS PDSCH and the dynamic PDSCH belong to the same pair of the reported RS pairs if groupBasedBeamReporting or groupBasedBeamReporting-r17 is configured, it is not necessary for the time gap between PDCCH and SPS PDSCH to be greater than the threshold Δ and the UE receives both the SPS PDSCH and the dynamic PDSCH.

Additionally, if the CORESETPoolIndex is configured and the PDCCH used for activating the SPS PDSCH belongs to CORESETPoolIndex, which differs from that used by the PDCCH scheduling the dynamic PDSCH, the UE may be able to receive the overlapping SPS PDSCH and dynamic PDSCH regardless of their indicated TCI state. For example, when a multi-TRP PDSCH reception using s-DCI is transmitted from a particular CORESETPoolIndex that differs from that used for SPS activation, regardless of the TCI of the dynamic PDSCH repetition, the UE may receive both the SPS PDSCH and the dynamic PDSCH, even when the time gap between the SPS PDSCH and the PDCCH scheduled the dynamic PDSCH is less than the threshold Δ.

Embodiments described above are equally applicable to cases in which the DCI schedules a single dynamic PDSCH or dynamic PDSCH repetitions.

Embodiments described for handling a collision between a dynamic PDSCH and an SPS PDSCH may be easily extended to embodiments in which a dynamic PUSCH and a configured grant (CG) PUSCH are associated with different TRPs.

For example, when a PDCCH scheduling a dynamic PUSCH, or a dynamic PUSCH scheduled by any DCI, is associated with a particular TRP, which differs from the TRP associated with a CG PUSCH, and both the dynamic PUSCH and the CG PUSCH overlap in the time domain, the UE may transmit both PUSCHs regardless of the time gap between an ending symbol of the PDCCH and a first symbol of the CG PUSCH.

This embodiment may be subject to UE capability (e.g., the UE may be capable of transmitting two PUSCHs using different panels at the UE side). The UE may indicate that it supports this feature using UE capability signaling. Alternatively, UE support for this feature may be inferred implicitly by the UE supporting any other feature requiring that the UE simultaneously transmit using two panels at the UE side.

The UE may also indicate, to the gNB (e.g., via UE capability signaling), a minimum time gap between the ending symbol of the PDCCH and the first symbol of the CG PUSCH, to support transmission of the dynamic PUSCH and the CG PUSCH overlapped in time domain and associated with different TRPs. This indicated minimum time gap may be smaller than the N₂ value that is applied when the dynamic PUSCH and the CG PUSCH are transmitted from the same TRP.

Therefore, with respect to UE behavior regarding a case in which the DCI schedules a single dynamic PUSCH or multiple dynamic PUSCHs, and the time gap between the last symbol of the PDCCH scheduling the dynamic PUSCH and the first symbol of the CG PUSCH is less than the threshold, any of the following may be considered.

With respect to an error case in which the UE does not expect that the dynamic PUSCH and the CG PUSCH are partially or fully overlapped in the time domain and are indicated or configured to be associated with the same TRP and the timeline is not satisfied, the TRP associated with the PUSCH may be indicated by any of the following methods.

Two different sounding reference signal (SRS) resource sets may be used to indicate a transmit precoder matrix indicator (TPMI)/SRS resource indicator (SRI) of the dynamic PUSCH and the CG PUSCH, where each is associated with a particular TRP. For example, the SRS set with the lowest ID may be associated with coresetPoolIndex 0, and the other SRS set may be associated with coresetPoolIndex 1. If the DCI scheduling the PUSCH is transmitted in the CORESET with coresetPoolIndex 0 and the DCI activating the CG PUSCH is associated with coresetPoolIndex 1, the corresponding SRS resource sets are applied and the UE assumes that the dynamic PUSCH and the CG PUSCH are associated with different TRPs.

The SRS may be explicitly configured with a particular coresetPoolIndex.

The DCI scheduling the dynamic PUSCH or activating the CG PUSCH may indicate the associated SRS set.

For a type 1 CG PUSCH, the associated TRP may be configured by RRC signaling (e.g., configure the coresetPoolIndex).

In case of using a TCI state to indicate the uplink beam, any of the above-described solutions for PDSCH may be used to associate the PUSCH with a particular TRP.

With respect to an error case in which the UE does not expect that the dynamic PUSCH and the SPS PUSCH are partially or fully overlapped in the time domain, and the information for determining the association with the TRP is not provided, indicated, or configured, indicating the TRP associated with the PUSCH may be realized using any of the aforementioned schemes.

With respect to a non-error case in which the UE receives both the overlapping dynamic PUSCH and CG PUSCH in the time domain based on UE capability, for example, the TRP associated with the PUSCH may be indicated using any of the above-described schemes.

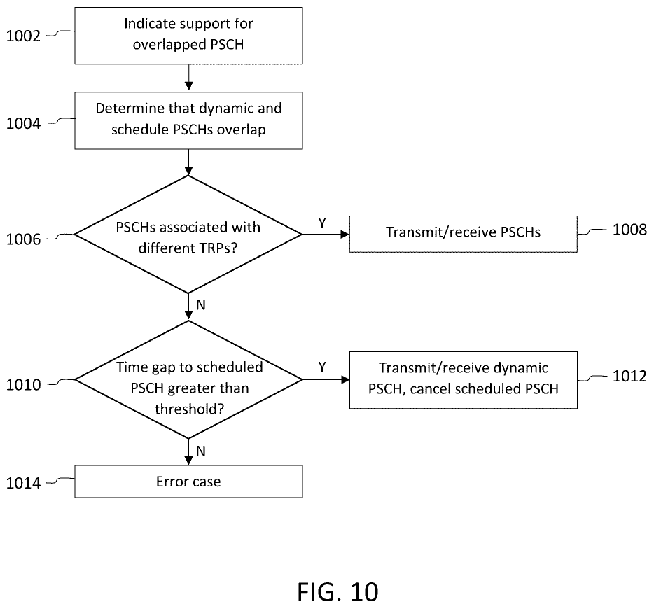

FIG. 10 is a flowchart illustrating a method of UE operation with overlapping dynamic and non-dynamic scheduled channels, according to an embodiment. At 1002, the UE may transmit an indication that it supports reception or transmission of a dynamic scheduled channel and a non-dynamic scheduled channel at least partially overlapped in the time domain.

At 1004, the UE may determine that the dynamic scheduled channel and the non-dynamic scheduled channel at least partially overlap in the time domain. The dynamic scheduled channel may be a dynamic PDSCH or a dynamic PUSCH, and the non-dynamic scheduled channel may be an SPS PDSCH or a CG PUSCH. The dynamic PDSCH may be one of repeated dynamic PDSCHs, with each repeated dynamic PDSCH associated with a different TRP. Similarly, the dynamic PUSCH may be one of repeated dynamic PUSCH, with each repeated dynamic PUSCH associated with a different TRP.

At 1006, the UE may determine whether the dynamic scheduled channel and the non-dynamic scheduled channel are associated with different TRPs. The UE may determine whether DCI for the channels is transmitted in CORESETs with different CORESET pool indices (e.g., coresetPoolIndex), and the different CORESET pool indices may indicate different TRPs. The UE may determine whether TCI states differ in MAC CEs that map the TCI states for codepoints in DCI for the channels, and different TCI states may indicate different TRPs. The TRPs for TCI states may be indicated in the MAC CEs that map the TCI states for codepoints in DCI, or may be configured by RRC signaling. The UE may determine whether QCL source RS s of TCI states of the channels have different set IDs, and different set IDs indicate different TRPs.

At 1008, the UE transmits or receives both the dynamic channel and the non-dynamic scheduled channel, if the dynamic scheduled channel and the non-dynamic scheduled channel are associated with different TRPs. The UE may receive the dynamic PDSCH and the SCS PDSCH, or may transmit the dynamic PUSCH and the CG PUSCH even if the timeline between the last symbol of the scheduling PDCCH and the first symbol of the SPS PDSCH or the CG PUSCH is less than the threshold. For transmission of the dynamic PUSCH and the CG PUSCH, a UCI may be multiplexed with one of the PUSCHs associated with the same TRP as that of the UCI.

At 1010, the UE may determine whether a time gap between the non-dynamic scheduled channel and the scheduling PDCCH for the dynamic scheduled channel is greater than a threshold, if the dynamic scheduled channel and the non-dynamic scheduled channel are not associated with different TRPs.

At 1012, the UE may transmit or receive the dynamic scheduled channel and may cancel the reception or the transmission of the scheduled channel, if the time gap is greater than the threshold. At 1014, an error case is attributed in case that the time gap is not greater than the threshold and the UE does not expect the overlap to occur.

In NR, a pdsch-AggregationFactor may be configured in a SPS-Config IE to indicate the number of repetitions for the SPS PDSCH within a single SPS period. If not configured, a pdsch-AggregationFactor in a PDSCH-Config IE may be applied.

When the UE is configured with a repetitionNumber in PDSCH-TimeDomainResourceAllocation and the SPS activation DCI indicates a codepoint of the DCI field ‘Transmission Configuration Indication’ associated with two TCI states, together with the DCI field ‘Time domain resource assignment’ indicating an entry which contains the repetitionNumber in PDSCH-TimeDomainResourceAllocation, one or a combination of the following may be applied.

The UE may ignore either the repetitionNumber or the pdsch-AggregationFactor and assume that the number of SPS repetitions is given by the other of the pdsch-AggregationFactor or the repetitionNumber, respectively. Across SPS PDSCH repetitions, the indicated TCI states may be applied cyclically or sequentially, as indicated in a RepetitionSchemeConfig IE. That is, within an SPS period, the mapping of TCI states to the SPS PDSCH repetitions may be similar to the mapping of TCI states relative to the dynamic PDSCH. Alternatively, a separate repetition scheme (cyclical or sequential) may be configured for SPS, and when it is not configured, the same repetition scheme for the RepetitionSchemeConfig IE may be applied. This is beneficial when different repetition schemes are configured for dynamic PDSCH scheduling and SPS.

The UE may determine the number of SPS PDSCH repetitions according to specified rules. For example, the number of repetitions may be given by repetitionNumber+pdsch-AggregationFactor, min (repetitionNumber, pdsch-AggregationFactor), max (repetitionNumber, pdsch-AggregationFactor), etc. Once the number of repetitions is determined, the schemes described above may be applied to map the TCI states to the SPS PDSCH repetitions.

The total number of SPS PDSCH repetitions given by the pdsch-AggregationFactor within a single SPS period may be divided into a number of sets, where each set contains the repetitionNumber of repetitions except the last set, which may contain mod(pdsch-AggregationFactor, repetitionNumber) if AggregationFactor/repetitionNumber is not integer. For each set, the indicated repetition scheme is applied either cyclically or sequentially based on the repetition type as described above.

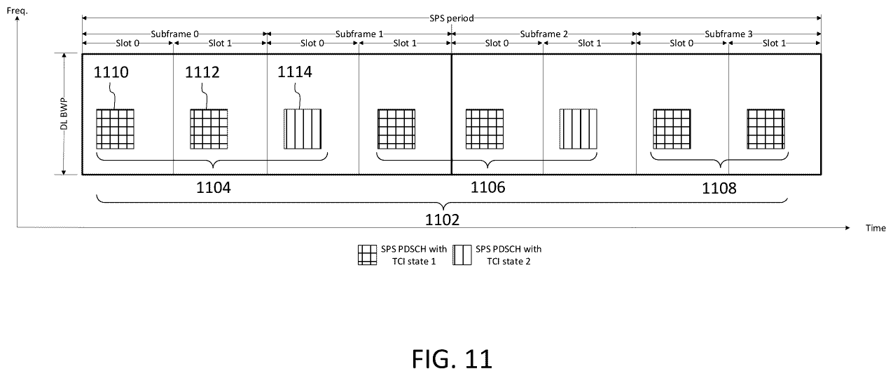

FIG. 11 is a diagram illustrating dividing PDSCH repetitions into multiple sets within an SPS period, according to an embodiment. Specifically, FIG. 11 shows an example in which pdsch-AggregationFactor=8 and repetitionNumber=3 (among the currently supported values in NR) in an SPS period. In this case, for a PDSCH aggregation factor 1102, first and second sets 1104 and 1106 of SPS PDSCH repetitions contain three SPS PDSCH repetitions, while a last set 1108 contains two SPS PDSCH repetitions. In FIG. 11, sequential mapping may be assumed. In the first and second sets 1104 and 1106, a first TCI state is applied to the first and second SPS PDSCH repetitions 1110 and 1112 in each set, while a second TCI state is applied to a third PDSCH repetition 1114 in each set.

For the last set 1108, the same TCI mapping rule may be applied as if the set has a complete number of SPS PDSCH repetitions, similar to other sets. When the last set has a fewer number of SPS PDSCH repetitions, the TCI mapping rule may be based on the actual number of SPS PDSCH repetitions in the set. As an alternative, the first and second TCI states may be applied to the first PDSCH repetition and the second PDSCH repetition in the last set, respectively.

When considered an error case, the UE may not expect a TDRA field in the SPS activation DCI to point to a row that has the repetitionNumber when the TCI field points to a codepoint associated with two TCI states. In this case, the UE may assume that the indicated TCI states are mapped across SPS PDSCH repetitions indicated by the pdsch-AggregationFactor, as described above.

When the UE is configured with the repetitionNumber in PDSCH-TimeDomainResourceAllocation and the SPS activation DCI indicates a codepoint of the DCI field ‘Transmission Configuration Indication’ associated with two TCI states, together with the DCI field ‘Time domain resource assignment’ not indicating an entry that contains the repetitionNumber in PDSCH-TimeDomainResourceAllocation, the following may be applied.

The UE may assume that repetitionNumber=pdsch-AggregationFactor that is configured in the SPS-Config IE or the PDSCH-Config IE, depending on which is applicable. Any of the embodiments described herein may be applied to determine the applied TCI state.

When the repetitionScheme is set to “tdmSchemeA” for the dynamic PDSCH, the UE may assume it is also applied to the SPS PDSCH. Alternatively, a separate repetitionScheme may be configured for SPS in order to provide the gNB with more flexibility when configuring the dynamic PDSCH and the SPS PDSCH.

When the repetitionScheme is set to “tdmSchemeA” for SPS using any of the embodiments described above, or any other method, and two TCI states corresponding to the indicated TCI codepoint are provided by DCI field ‘Transmission Configuration Indication’ in the SPS activation DCI, the UE may understand that tdmSchemeA is to be applied for SPS. This may be applied using one or combination of the following methods.

If the pdsch-AggregationFactor is not configured, or configured and set to 1, the UE may assume that the SPS PDSCH is repeated twice (e.g., may be transmitted with same or different redundancy versions (RVs)) with a StartingSymbolOffsetK symbol gap between the last symbol of a first SPS PDSCH repetition and the first symbol of a second SPS PDSCH repetition. The first indicated TCI state is applied to the first PDSCH repetition and the second indicated TCI state is applied to the second PDSCH repetition.

The same StartingSymbolOffsetK parameter of the dynamic PDSCH may be used for both the SPS PDSCH and the dynamic PDSCH. Alternatively, a separate parameter may be configured (e.g., as part of SPS-Config), and when not configured, the parameter for the dynamic PDSCH may be applied.

If the pdsch-AggregationFactor is set to be greater than 1 (e.g., 2, 4 or 8), the UE may assume that pdsch-AggregationFactor/2 slots are used for transmitting the SPS PDSCH repetitions, where each slot has two SPS PDSCH repetitions spaced by the StartingSymbolOffsetK. The first indicated TCI state may be applied to the first SPS PDSCH repetition and the second indicated TCI state may be applied to the second SPS PDSCH repetition in each slot.

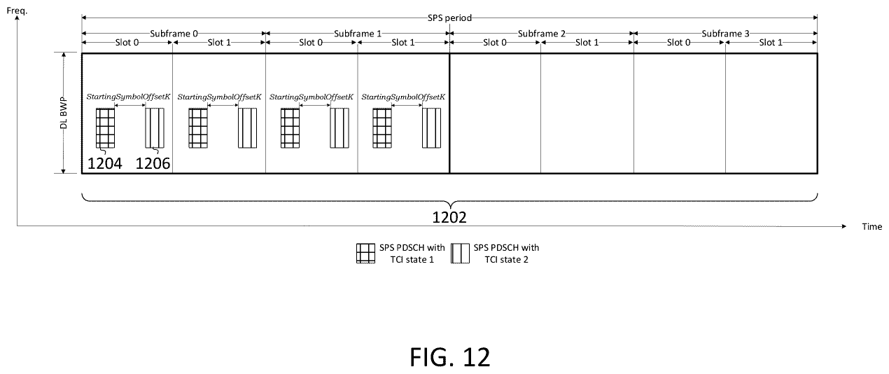

FIG. 12 is a diagram illustrating allocated slots for the SPS PDSCH repetitions using a TDM scheme (tdmSchemeA), according to an embodiment. Specifically, FIG. 12 shows an example of pdsch-AggregationFactor set to 8, but rather than having SPS PDSCH transmitted in 8 slots within an SPS period, for a PDSCH aggregation factor 1202, only 4 slots are used (e.g., slots 0 and 1 of subframes 0 and 1), with each slot having a first SPS PDSCH 1204 transmitted with a first TCI state and a second SPS PDSCH 1206 transmitted with a second TCI state.

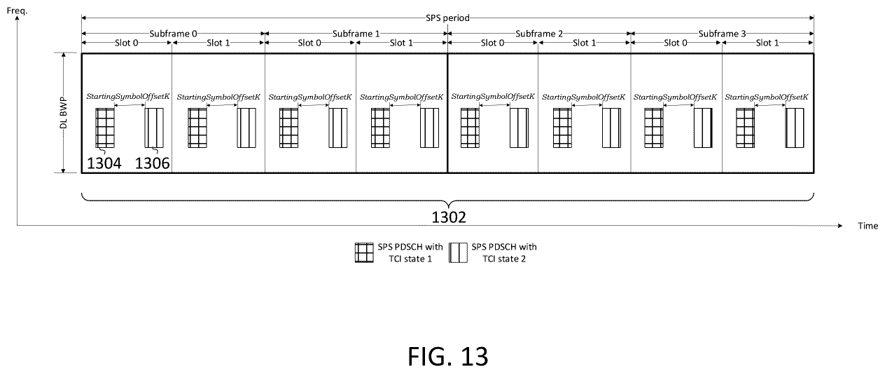

FIG. 13 is a diagram illustrating allocated slots for the SPS PDSCH repetitions using a TDM scheme (tdmSchemeA), according to another embodiment. If pdsch-AggregationFactor is set to be greater than 1 (e.g., 2, 4 or 8), the number of slots may remain the same as indicated by pdsch-AggregationFactor. In each slot, the SPS PDSCH is repeated twice with StartingSymbolOffsetK symbols in-between, as described above. In this case, the total number of transmitted PDSCHs is 2*pdsch-AggregationFactor. In FIG. 13, pdsch-AggregationFactor is set to 8 and the SPS PDSCH is transmitted in 8 slots (e.g., slots 0 and 1 of subframes 0, 1, 2, and 3) within an SPS period. For a PDSCH aggregation factor 1302, each slot has a first SPS PDSCH 1304 transmitted with the first TCI state and a second SPS PDSCH 1306 transmitted with the second TCI state.

For an error case, the UE may not expect to be configured with “tdmSchemeA” for SPS, and the pdsch-AggregationFactor may be configured or determined to be more than one.

When the repetitionScheme is set to “fdmSchemeB” for the dynamic PDSCH, the UE may assume it is applied to the SPS PDSCH as well. Alternatively, a separate repetitionScheme may be configured for SPS to provide the gNB with more flexibility when configuring the dynamic PDSCH and the SPS PDSCH.

When repetitionScheme is set to “fdmSchemeB” for SPS using any of the methods described above, or any other method, and two TCI states corresponding to the indicated TCI codepoint are provided by DCI field ‘Transmission Configuration Indication’ in the SPS activation DCI, the UE determines that fdmSchemeB is to be applied for SPS. This may be applied using one or a combination of the following methods.

The UE may receive two SPS PDSCHs that are non-overlapping in the frequency domain. One or a combination of the following may be applied.

If pdsch-AggregationFactor is not configured, or configured and set to 1, the UE may assume that the SPS PDSCH is repeated twice (e.g., transmitted with the same or a different RV). The two PDSCHs are FDMed. Regarding the determination of the precoding resource group (PRG) and the allocated physical resource blocks (PRBs) for each PDSCH, the approach for dynamic PDSCH may be applied.

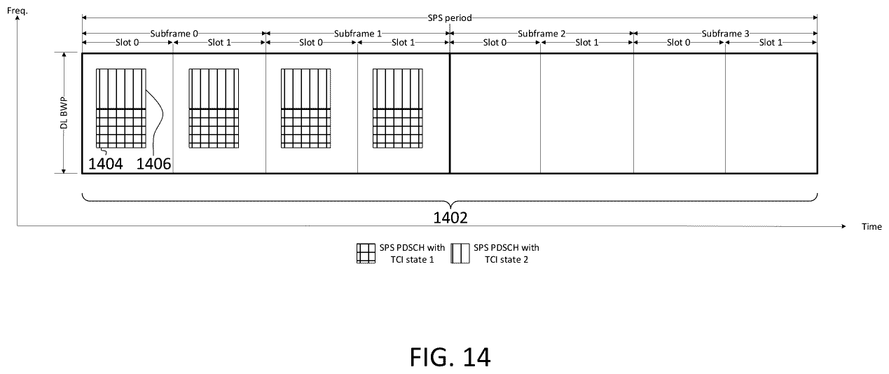

FIG. 14 is a diagram illustrating allocated slots for SPS PDSCH repetitions using an FDM scheme, according to an embodiment. If the pdsch-AggregationFactor is set to be greater than 1 (e.g., 2, 4 or 8), the UE may assume that pdsch-AggregationFactor/2 slots are used for transmitting SPS PDSCH where each slot has two FDMed SPS PDSCHs. In FIG. 14, the pdsch-AggregationFactor is set to 8, but rather than having SPS PDSCH transmitted in eight slots within an SPS period, for a PDSCH aggregation factor 1402, only four slots are used (e.g., slots 0 and 1 of subframes 0 and 1), where each slot has first and second FDMed SPS PDSCH repetitions 1404 and 1406 transmitted with the first and second indicated TCI states, respectively.

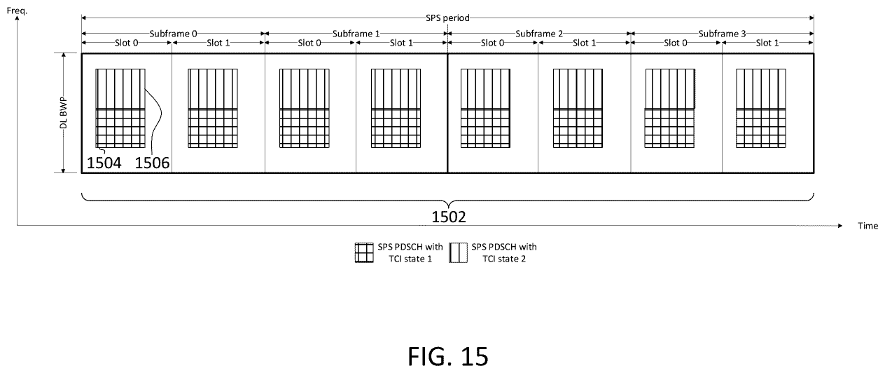

FIG. 15 is a diagram illustrating allocated slots for SPS PDSCH repetitions using an FDM scheme, according to another embodiment. If the pdsch-AggregationFactor is set to be greater than 1 (e.g., 2, 4 or 8), the number of slots may remain the same as indicated by the pdsch-AggregationFactor. In each slot, SPS PDSCH is repeated twice in frequency. In this case, the total number of transmitted PDSCH repetitions is 2*pdsch-AggregationFactor. In FIG. 15, the pdsch-AggregationFactor is set to 8 and the SPS PDSCH repetitions are transmitted in 8 slots (e.g., slots 0 and 1 of subframes 0, 1, 2, and 3) within an SPS period. For a PDSCH aggregation factor 1502, each slot has first and second FDMed SPS PDSCHs 1504 and 1506 transmitted with the first and second indicated TCI states, respectively.

For an error case, the UE may not expect to be configured with “fdmSchemeB” for SPS, and the pdsch-AggregationFactor may be configured or determined to be more than 1.

The embodiment developed for fdmSchemeB may be easily extended to fdmSchemeA. In fdmSchemeA, only a single PDSCH is transmitted where some layers are transmitted using the first indicated TCI state, and another set of layers are transmitted using the second indicated TCI state.

For any of the embodiments described above, the UE may indicate to the gNB whether it can support such repetition schemes for SPS as part of its capability signaling, for example. It may be assumed that supporting a particular repetition scheme for the dynamic PDSCH means that the same repetition scheme is supported for SPS. This may reduce the signaling overhead.

The capability indications of the repetition scheme for the dynamic PDSCH and the SPS PDSCH may be decoupled. This may provide the UE with more flexibility to support different repetition schemes for the dynamic PDSCH and the SPS PDSCH.

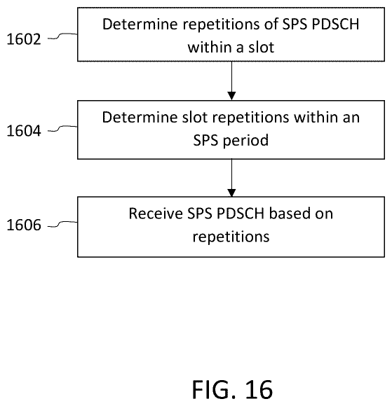

FIG. 16 is a flowchart illustrating a method of SPS PDSCH repetition in an SPS period, according to an embodiment. At 1602, the UE may determine a first number of repetitions of an SPS PDSCH within a given slot. First and second TCI states may be provided for the SPS PDSCH by DCI of the SPS PDSCH. The UE may determine a repetition scheme for the first number of repetitions based on the repetition scheme of the dynamic PDSCH. Alternatively, the UE may receive a configuration for the repetition scheme for the first number of repetitions that is configured for SPS separately from the dynamic PDSCH. The first TCI state may be applied to a first SPS PDSCH repetition in the given slot, and the second TCI state may be applied to a second SPS PDSCH repetition in the given slot.

The repetition scheme may be a TDM scheme, the first SPS PDSCH repetition and the second SPS PDSCH repetition may occupy the same RB s, and a time offset between a last symbol for the SPS PDSCH repetition and a first symbol of the second PDSCH repetition may be identical to that of the dynamic PDSCH or may be configured for SPS separately from the dynamic PDSCH. The repetition scheme may be an FDM scheme, and the first SPS PDSCH repetition and the second SPS PDSCH repetition may overlap in the time domain and may be adjacent in the frequency domain.

At 1604, the UE may determine a second number of slot repetitions within an SPS period based on at least one of an aggregation factor of an IE and a repetition number of a TDRA. The second number of slot repetitions may be equal to the aggregation factor or half of the aggregation factor. The second number of slot repetitions may be based on the aggregation factor without the repetition number, the repetition number without the aggregation factor, or a predefined rule based on both the aggregation factor and the repetition number.

The second number of slot repetitions may be based on the aggregation factor, where the second number of slot repetitions may include one or more sets, with each of the one or more sets having a third number of slots corresponding to the repetition number. The first and second TCI states may be applied to the third number of slots in each of the one or more sets based on sequential or cyclical mapping. The second number of slot repetitions may include a last set having a fourth number of slots that is less than the third number of slots. The first and second TCI states may be applied to the last set based on sequential mapping or cyclical mapping based on the third number of slots or the fourth number of slots.

At 1606, the UE may receive the SPS PDSCH in accordance with the first number of repetitions within the given slot and the second number of slot repetitions within the SPS period.

Enhancements for m-DCI m-TRP PUSCH transmission schemes were introduced in 3GPP Rel-16 MIMO, in which the UE may transmit the PUSCHs toward different TRPs by associating a PUSCH to a TRP through the RRC parameter CORESETPoolIndex. Enhancements to a s-DCI M-TRP PUSCH transmission (TDM) schemes as well as m-TRP physical uplink control channel (PUCCH) repetitions were introduced in 3GPP Rel-17.

While no enhancement may be needed for an s-DCI uplink m-TRP transmission, an m-DCI uplink transmission may be different. In NR, the UE is not expected to transmit overlapping PUSCHs or overlapping PUSCHs and PUCCHs in the time domain. In this case, the UE may naturally follow a specified behavior (e.g., UCI multiplexing and PUSCH selection/transmission), while the gNB may ensure that the UE would not need to transmit two overlapping uplink channels towards two different TRPs.

In 3GPP Rel-18, simultaneous uplink transmissions towards different TRPs using different panels may be supported, in which case an enhancement may be needed to avoid multiplexing of UL channels aimed toward different TRPs. An association may be defined between any UL channel and a TRP, as set forth below.

For a dynamic grant (DG) PUSCH, a PUSCH may be associated with a TRP through the value of the CORESETPoolIndex configured for the CORESET in which the scheduling DCI is transmitted. The association may also be defined dynamically via the DCI.

For a type-2 CG PUSCH, the association may be similar to DG PUSCH via the activation DCI.

For type-1 CG, the association may be defined via RRC signaling (e.g. the value of C ORES TEPoolIndex).

For hybrid automatic repeat request (HARQ)-acknowledgement (ACK) DG PUCCH, the association may be defined via an association of the DG PDSCHs to the TRPs (e.g. via CORESETPoolIndex).

For SPS acknowledge/negative-acknowledge PUCCH, the association may be defined based on the association of the SPS PDSCHs and the TRPs (e.g. the value of CORSETPoolIndex for the activation DCI or RRC configuration).

For scheduling request (SR) PUCCH, the association may be defined via RRC for each SR configuration.

For periodic (P)-CSI PUCCH, the association may be defined via an RRC configuration in the CSI report or measurement configuration.

For semi-periodic (SP)-CSI PUCCH, the association may be defined similar to the P-CSI PUCCH or based on the MAC CE activation DCI association (e.g. the value of the CORSETPoolIndex for the CORESET of the DCI transmission).

Once every PUCCH or PUSCH transmission in a slot is associated with a TRP, the UE may perform UCI multiplexing, PUSCH selection for UCI multiplexing, UCI piggybacking in PUSCH, etc., per TRP independently for the two TRPs. The UE may end up transmitting overlapping PUCCHs or PUSCHs if they are transmitted towards different TRPs.

For example, if the UE transmits one TRP 1 PUCCH, one TRP 1 PUSCH, and one TRP 2 PUSCH, such that the PUCCH overlaps with both PUSCHs, the UE may multiplex the PUCCH in the TRP 1 PUSCH, and transmit the two PUSCHs.

In NR, if the UE has multiple SPS PDSCH occasions overlapping in a slot, the UE may select one resource among the overlapping resources based on the SPS configuration index.

The intention of the selection procedure is to prevent simultaneous reception of overlapping PDSCHs, as it requires advanced capabilities. When the SPS PDSCHs are associated with different TRPs, the selection procedure may be performed per TRP, allowing for the possible reception of two overlapping PDSCHs from the two TRPs provided that UE declares the related capability.

With multiple active CG configurations per UL BWP, the selection procedure similar to that used for handling overlapping SPS PDSCH may be reused for UL CG collision handling, such that there is a common understanding between the UE and the gNB on which CG occasion is used for UL transmission, and the UE will not transmit two overlapping PUSCHs.

With respect to a m-DCI PUSCH transmission, since the UE is capable of transmitting overlapping PUSCHs, the aforementioned collision handling may be applied per TRP. That is, the UE may resolve the overlapping PUSCHs for each TRP independently. It may then transmit overlapping PUSCHs toward the different TRPs.

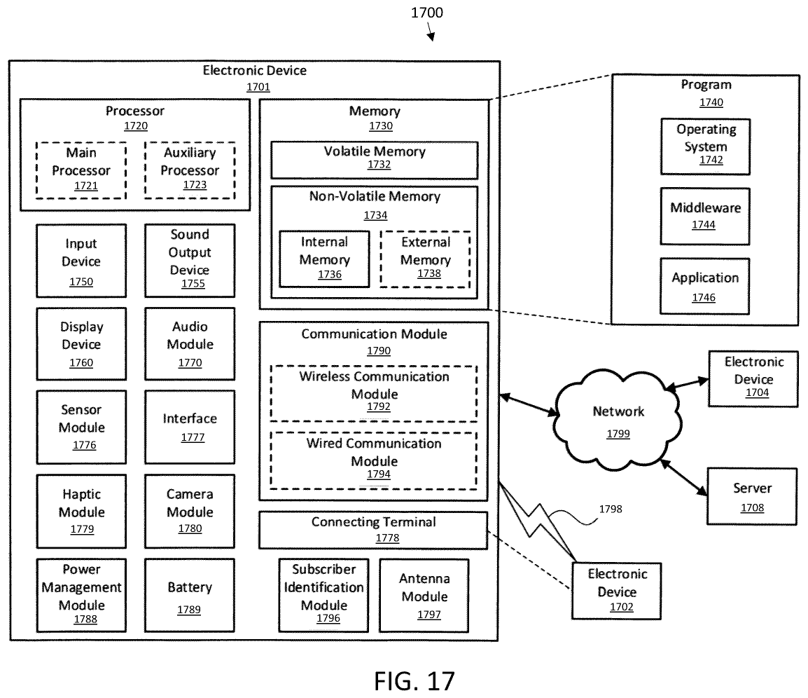

FIG. 17 is a block diagram of an electronic device in a network environment 1700, according to an embodiment.

Referring to FIG. 17, an electronic device 1701 in a network environment 1700 may communicate with an electronic device 1702 via a first network 1798 (e.g., a short-range wireless communication network), or an electronic device 1704 or a server 1708 via a second network 1799 (e.g., a long-range wireless communication network). The electronic device 1701 may communicate with the electronic device 1704 via the server 1708. The electronic device 1701 may be embodied as a UE, and may communicate with a gNB via the second network 1799.

The electronic device 1701 may include a processor 1720, a memory 1730, an input device 1750, a sound output device 1755, a display device 1760, an audio module 1770, a sensor module 1776, an interface 1777, a haptic module 1779, a camera module 1780, a power management module 1788, a battery 1789, a communication module 1790, a subscriber identification module (SIM) card 1796, or an antenna module 1797. In one embodiment, at least one (e.g., the display device 1760 or the camera module 1780) of the components may be omitted from the electronic device 1701, or one or more other components may be added to the electronic device 1701. Some of the components may be implemented as a single integrated circuit (IC). For example, the sensor module 1776 (e.g., a fingerprint sensor, an iris sensor, or an illuminance sensor) may be embedded in the display device 1760 (e.g., a display).

The processor 1720 may execute software (e.g., a program 1740) to control at least one other component (e.g., a hardware or a software component) of the electronic device 1701 coupled with the processor 1720 and may perform various data processing or computations.

As at least part of the data processing or computations, the processor 1720 may load a command or data received from another component (e.g., the sensor module 1776 or the communication module 1790) in volatile memory 1732, process the command or the data stored in the volatile memory 1732, and store resulting data in non-volatile memory 1734. The processor 1720 may include a main processor 1721 (e.g., a central processing unit (CPU) or an application processor (AP)), and an auxiliary processor 1723 (e.g., a graphics processing unit (GPU), an image signal processor (ISP), a sensor hub processor, or a communication processor (CP)) that is operable independently from, or in conjunction with, the main processor 1721. Additionally or alternatively, the auxiliary processor 1723 may be adapted to consume less power than the main processor 1721, or execute a particular function. The auxiliary processor 1723 may be implemented as being separate from, or a part of, the main processor 1721.

The auxiliary processor 1723 may control at least some of the functions or states related to at least one component (e.g., the display device 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). The auxiliary processor 1723 (e.g., an image signal processor or a communication processor) may be implemented as part of another component (e.g., the camera module 1780 or the communication module 1790) functionally related to the auxiliary processor 1723.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734. Non-volatile memory 1734 may include internal memory 1736 and/or external memory 1738.

The program 1740 may be stored in the memory 1730 as software, and may include, for example, an operating system (OS) 1742, middleware 1744, or an application 1746.

The input device 1750 may receive a command or data to be used by another component (e.g., the processor 1720) of the electronic device 1701, from the outside (e.g., a user) of the electronic device 1701. The input device 1750 may include, for example, a microphone, a mouse, or a keyboard.

The sound output device 1755 may output sound signals to the outside of the electronic device 1701. The sound output device 1755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1760 may visually provide information to the outside (e.g., a user) of the electronic device 1701. The display device 1760 may include, for example, a display, a hologram device, or a projector and control circuitry to control a corresponding one of the display, hologram device, and projector. The display device 1760 may include touch circuitry adapted to detect a touch, or sensor circuitry (e.g., a pressure sensor) adapted to measure the intensity of force incurred by the touch.

The audio module 1770 may convert a sound into an electrical signal and vice versa. The audio module 1770 may obtain the sound via the input device 1750 or output the sound via the sound output device 1755 or a headphone of an external electronic device 1702 directly (e.g., wired) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. The sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device 1702 directly (e.g., wired) or wirelessly. The interface 1777 may include, for example, a high-definition multimedia interface (HDMI), a universal serial bus (USB) interface, a secure digital (SD) card interface, or an audio interface.

A connecting terminal 1778 may include a connector via which the electronic device 1701 may be physically connected with the external electronic device 1702. The connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or an electrical stimulus which may be recognized by a user via tactile sensation or kinesthetic sensation. The haptic module 1779 may include, for example, a motor, a piezoelectric element, or an electrical stimulator.

The camera module 1780 may capture a still image or moving images. The camera module 1780 may include one or more lenses, image sensors, image signal processors, or flashes. The power management module 1788 may manage power supplied to the electronic device 1701. The power management module 1788 may be implemented as at least part of, for example, a power management integrated circuit (PMIC).

The battery 1789 may supply power to at least one component of the electronic device 1701. The battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the AP) and supports a direct (e.g., wired) communication or a wireless communication. The communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as BLUETOOTH™, wireless-fidelity (Wi-Fi) direct, or a standard of the Infrared Data Association (IrDA)) or the second network 1799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The antenna module 1797 may transmit or receive a signal or power to or from the outside (e.g., the external electronic device) of the electronic device 1701. The antenna module 1797 may include one or more antennas, and, therefrom, at least one antenna appropriate for a communication scheme used in the communication network, such as the first network 1798 or the second network 1799, may be selected, for example, by the communication module 1790 (e.g., the wireless communication module 1792). The signal or the power may then be transmitted or received between the communication module 1790 and the external electronic device via the selected at least one antenna.

Commands or data may be transmitted or received between the electronic device 1701 and the external electronic device 1704 via the server 1708 coupled with the second network 1799. Each of the electronic devices 1702 and 1704 may be a device of a same type as, or a different type, from the electronic device 1701. All or some of operations to be executed at the electronic device 1701 may be executed at one or more of the external electronic devices 1702, 1704, or 1708. For example, if the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1701. The electronic device 1701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
determining, by a user equipment (UE), a first number of repetitions of a semi-persistent scheduling (SPS) physical downlink shared channel (PDSCH) within a given slot;
determining, by the UE, a second number of slot repetitions within an SPS period based on at least one of an aggregation factor of an information element (IE) or a repetition number of a time domain resource allocation; and
receiving, by the UE, the SPS PDSCH in accordance with the first number of repetitions within the given slot and the second number of slot repetitions within the SPS period.

2. The method of claim 1, wherein first and second transmission configuration identifier (TCI) states are provided for the SPS PDSCH by downlink control information (DCI) activating the SPS PDSCH.

3. The method of claim 2, further comprising:
applying, by the UE, a repetition scheme for the first number of repetitions based on the dynamic PDSCH; or
receiving, by the UE, a configuration for the repetition scheme for the first number of repetitions that is configured for SPS separately from the dynamic PDSCH.

4. The method of claim 3, wherein:
the first TCI state is applied to a first SPS PDSCH repetition in the given slot and the second TCI state is applied to a second SPS PDSCH repetition in the given slot; and
the second number of slot repetitions is equal to the aggregation factor or half of the aggregation factor.

5. The method of claim 4, wherein the repetition scheme is a time domain multiplexing (TDM) scheme, the first SPS PDSCH repetition and the second SPS PDSCH repetition overlap in the frequency domain, and a time offset between a last symbol of the first SPS PDSCH repetition and a first symbol of the second PDSCH repetition is identical to that of the dynamic PDSCH or is configured for SPS separately from the dynamic PDSCH.

6. The method of claim 4, wherein the repetition scheme is a frequency domain multiplexing (FDM) scheme, and the first SPS PDSCH repetition and the second SPS PDSCH repetition overlap in a time domain and are adjacent in a frequency domain.

7. The method of claim 2, wherein the second number of slot repetitions is based on:
the aggregation factor, without the repetition number;
the repetition number, without the aggregation factor; or
a predefined rule based on both the aggregation factor and the repetition number.

8. The method of claim 2, wherein the second number of slot repetitions is based on the aggregation factor, wherein the second number of slot repetitions comprises one or more sets, with each of the one or more sets having a third number of slots corresponding to the repetition number.

9. The method of claim 8, wherein the first and second TCI states are applied to the third number of slots in each of the one or more sets based on sequential or cyclical mapping.

10. The method of claim 8, wherein:
the second number of slot repetitions comprises a last set having a fourth number of slots that is less than the third number of slots; and
the first and second TCI states are applied to the last set based on sequential mapping or cyclical mapping based on the third number of slots or the fourth number of slots.

11. The method of claim 2, wherein, when receiving the aggregation factor at the UE, the UE does not expect to receive or apply a configuration for a repetition scheme for the first number of repetitions, or does not expect to receive the second number of slot repetitions based on the time domain resource allocation.

12. A user equipment (UE) comprising:
a processor; and
a non-transitory computer readable storage medium storing instructions that, when executed, cause the processor to:
determine a first number of repetitions of a semi-persistent scheduling (SPS) physical downlink shared channel (PDSCH) within a given slot;
determine a second number of slot repetitions within an SPS period based on at least one of an aggregation factor of an information element (IE) or a repetition number of a time domain resource allocation; and
receive the SPS PDSCH in accordance with the first number of repetitions within the given slot and the second number of slot repetitions within the SPS period.

13. The UE of claim 12, wherein first and second transmission configuration identifier (TCI) states are provided for the SPS PDSCH by downlink control information (DCI) activating the SPS PDSCH.

14. The UE of claim 12, wherein the instructions further cause the processor to:
apply a repetition scheme for the first number of repetitions based on the dynamic PDSCH; or
receive a configuration for the repetition scheme for the first number of repetitions that is configured for SPS separately from the dynamic PDSCH.

15. The UE of claim 14, wherein:
the first TCI state is applied to a first SPS PDSCH repetition in the given slot and the second TCI state is applied to a second SPS PDSCH repetition in the given slot; and
the second number of slot repetitions is equal to the aggregation factor or half of the aggregation factor.

16. The UE of claim 15, wherein the repetition scheme is a time domain multiplexing (TDM) scheme, the first SPS PDSCH repetition and the second SPS PDSCH repetition overlap in the frequency domain, and a time offset between a last symbol of the first SPS PDSCH repetition and a first symbol of the second PDSCH repetition is identical to that of the dynamic PDSCH or is configured for SPS separately from the dynamic PDSCH.

17. The UE of claim 15, wherein the repetition scheme is a frequency domain multiplexing (FDM) scheme, and the first SPS PDSCH repetition and the second SPS PDSCH repetition overlap in a time domain and are adjacent in a frequency domain.

18. The UE of claim 13, wherein the second number of slot repetitions is based on:
the aggregation factor, without the repetition number;
the repetition number, without the aggregation factor; or
a predefined rule based on both the aggregation factor and the repetition number.

19. The UE of claim 13, wherein:
the second number of slot repetitions is based on the aggregation factor, wherein the second number of slot repetitions comprises one or more sets, with each of the one or more sets having a third number of slots corresponding to the repetition number;
the first and second TCI states are applied to the third number of slots in each of the one or more sets based on sequential or cyclical mapping;
the second number of slot repetitions comprises a last set having a fourth number of slots that is less than the third number of slots; and
the first and second TCI states are applied to the last set based on sequential mapping or cyclical mapping based on the third number of slots or the fourth number of slots.

20. A method comprising:
determining, by the UE, a first number of slot repetitions within a semi-persistent scheduling (SPS) period for an SPS physical downlink shared channel (PDSCH) based on at least one of an aggregation factor of an information element (IE) or a repetition number of a time domain resource allocation; and
receiving, by the UE, the SPS PDSCH in accordance with the first number of slot repetitions within the SPS period,
wherein the first number of slot repetitions is based on the aggregation factor and comprises one or more sets, with each of the one or more sets having a second number of slots corresponding to the repetition number, and a last set having a third number of slots that is less than or equal to the second number of slots.
